(19) United States
(12) Patent Application Publication
(10) Pub. No.: US 2024/0351374 A1
(43) Pub. Date: Oct. 24, 2024

(54) BICYCLE REAR-WHEEL DRIVE MECHANISM

(71) Applicants: Dongguan Jingtong Machinery Technology Co., Ltd., Dongguan (CN); Xi'an Xiongfeng Energy Saving Technology Co., Ltd., Xi'an (CN)

(72) Inventors: Quanxi Liu, Dongguan (CN); Xiaoying Wang, Dongguan (CN); Yu Liu, Dongguan (CN); Nianguo Wang, Dongguan (CN); Jianyi Liu, Dongguan (CN); Chan Li, Dongguan (CN); Qing Liu, Xi'an (CN)

(21) Appl. No.: 18/639,574

(22) Filed: Apr. 18, 2024

(30) Foreign Application Priority Data
Apr. 19, 2023 (CN) 2023208793928

(51) Int. Cl. B60B 27/04; B60B 27/02; B62M 9/02

(52) U.S. Cl. CPC B60B 27/047; B60B 27/023; B62M 9/02; B60B 2200/47; B60B 2900/113; B60B 2900/212; B60B 2900/5118; B60B 2900/541; B60B 2900/561

(57) ABSTRACT

A bicycle rear-wheel drive mechanism comprises a fixed shaft, a hollow toothed disc shaft, a wheel shaft, a sprocket shaft, an end cap and pin posts, the hollow toothed disc shaft is composed of a shaft cylinder and a toothed disc arranged at one end of the shaft cylinder, the toothed disc is provided with an array of semi-circular slots located at the edge of the disc body; in this design, the structure is stronger, the torque transmitted is greater, and the driving ability is stronger; replacing the original ball bearings used in bicycles with standardized tapered roller bearings allows the mechanism to be adjusted to the optimal axial and radial positions after installation, while also improving sealing performance and durability.

### 1. TECHNICAL FIELD

The invention relates to the technical field of bicycle transmission, in particular to a bicycle rear-wheel drive mechanism.

### 2. BACKGROUND ART

In existing designs of bicycle rear drive wheels, the principle of a ratchet and pawl one-way transmission mechanism is mainly used to drive the rotation of the rear wheel of the bicycle, thus providing the power for the bicycle to move forward. Additionally, there is a shaft drive method that does not use chains to drive the rear wheel to bicycle. However, it has been found in practice that both the two methods have certain shortcomings:

The bicycle with a ratchet and pawl transmission system has the following drawbacks: typically, in conventional bicycles employing this type of ratchet, there are two symmetrical pawls engaging with the inner ratchet; when driving the wheel, the bicycle's rear inner and outer wheels are connected and rotated together by these two pawls; when forcefully pedaling the front sprocket wheel, the two pawls bear a significant load, due to the shallow engagement of the ratchet and pawls, the teeth on them are prone to damage, the overall load-bearing capacity of the bicycle is insufficient; the internal structure of the ratchet and pawl transmission section is narrow, typically requiring a certain number of ball bearings to replace end face bearings and radial bearings. However, without a cage, these steel balls can only adhere to the raceway with butter; in this way, maintenance and installation are cumbersome; additionally, due to sealing issues, these steel balls wear and deform over time, resulting in abnormal noise.

The drawbacks of the bicycle with the shaft drive method are as follows: although its transmission torque is greater than ratchet-type transmission torque, its manufacturing cost is high, its transmission components such as bevel gears and shafts are difficult to process, and they increase the weight of the bicycle itself; moreover, the efficiency of the mechanism transmission is low, mechanical losses are significant due to the presence of multiple transmission links in the mechanism transmission.

In order to solve the drawbacks of the above two commonly used bicycle driving mechanisms, there is an urgent need to design a bicycle transmission mechanism.

### 3. SUMMARY OF THE INVENTION

The technical problem to be solved by the invention is to overcome the defect of the above technology and provide a bicycle rear-wheel drive mechanism.

To solve the above technical problem, the invention provides the following technical scheme: a bicycle rear-wheel drive mechanism comprises a fixed shaft, a hollow toothed disc shaft, a wheel shaft, a sprocket shaft, an end cap and pin posts, the hollow toothed disc shaft is composed of a shaft cylinder and a toothed disc arranged at one end of the shaft cylinder, the toothed disc is provided with an array of semi-circular slots located at the edge of the disc body;
a first bearing chamber is arranged at one end of the wheel shaft, and a first bearing is arranged inside the first bearing chamber, the outer peripheral surface of the wheel shaft is provided with two spoke mounting plates along the axial direction, and the axis of the wheel shaft is provided with a first shaft hole;
an annular groove is arranged on one side of the sprocket shaft, a second shaft hole is arranged in the center of the annular groove, and the annular groove is provided with second pin holes in a circumferential array near the edge of the bottom of the groove, which are designed to work in conjunction with the semi-circular grooves;
the end of the shaft cylinder of the hollow toothed disc shaft away from the toothed disc penetrates the second shaft hole and the first shaft hole in sequence and then extends to the first bearing chamber, the toothed disc is located inside the annular groove;
the notch of the annular groove is snap-fitted with the end cap, the side of the end cap near the annular groove is provided with first pin holes coaxially arranged with the second pin holes, the pin posts are located inside the cylindrical regions formed by the first pin holes and the second pin holes, springs are arranged between the pin posts and the bottoms of the second pin holes, the pin posts are provided with grooves on one side of their bodies facing the central axis of the toothed disc;
on the side of the end cap facing away from the annular groove, a second bearing chamber is located at the center of the cap body, the center of the second bearing chamber is provided with a third shaft hole, the interior of the second bearing chamber is provided with a second bearing;
the fixed shaft is arranged inside the shaft cylinder, the first bearing and the second bearing are respectively sleeved on the outer peripheral surfaces of the shaft journals on both sides of the fixed shaft.

As an improvement, an acute angle is set between one groove wall of the groove of the pin post near the wheel shaft and the axis of the pin post, the other groove wall of the groove of is perpendicular to the axis of the pin post, the distance between the two groove walls of the groove is slightly larger than the thickness of the toothed disc, the angle formed by the groove wall planes on both sides of the groove points to the direction in which the sprocket shaft drives the hollow toothed disc shaft to rotate.

As an improvement, the fixed shaft and the shaft cylinder are coaxially arranged, and the outer diameter of the fixed shaft is smaller than the inner diameter of the shaft cylinder.

As an improvement, the spoke mounting plates are provided with mounting holes evenly around their edges for installing spokes.

As an improvement, a sprocket gear is fixed on the outer peripheral surface of the sprocket shaft.

As an improvement, the hollow toothed disc shaft is axially provided with a keyway on the outer circumferential surface, the hollow toothed disc shaft and the wheel shaft are circumferentially fixed by a key, which is arranged inside the keyway.

As an improvement, second screw holes are arranged at the notch of the annular groove, first screw holes are arranged at the edge of the cover body of the end cap, the axes of the first screw holes and the second screw holes are coincident and the apertures are equal, fixing studs extend into the first screw holes and the second screw holes in turn.

As an improvement, the two ends of the fixed shaft are respectively connected with bushings of the bicycle frame.

As an improvement, the diameter of the toothed disc is slightly smaller than the inner diameter of the annular groove.

The invention has the following advantageous effects:
1. the locking posts in this design can be designed into multiple numbers as needed, the structure is stronger, the torque transmitted is greater, and the driving ability is stronger;
2. replacing the original ball bearings used in bicycles with standardized tapered roller bearings allows the mechanism to be adjusted to the optimal axial and radial positions after installation, while also improving sealing performance and durability, making it easier for installation and maintenance;
3. one-way transmission mechanism, due to its excellent sealing performance, is easier to fully lubricate when compared with the ratchet and pawl one-way transmission.

### 4. BRIEF DESCRIPTION OF ACCOMPANY DRAWINGS

FIG. 1 is a schematic diagram of the external structure of the drive mechanism;

FIG. 2 is a schematic diagram of the internal structure of the drive mechanism;

FIG. 3 is an exploded schematic diagram of the components of the drive mechanism from a first perspective;

FIG. 4 is an exploded schematic diagram of the components of the drive mechanism from a second perspective;

FIG. 5 is a schematic diagram of the structure of the wheel shaft from a first perspective;

FIG. 6 is a schematic diagram of the structure of the wheel shaft from a second perspective;

FIG. 7 is a schematic diagram of the structure of the sprocket shaft;

FIG. 8 is a schematic diagram of the structure of end cap;

FIG. 9 is a schematic diagram of the structure of the hollow toothed disc shaft;

FIG. 10 is a schematic diagram of the structure of the pin post.

As shown in the figures: 1 fixed shaft, 101 shaft journal, 2 hollow toothed disc shaft, 201 shaft cylinder, 202 toothed disc, 203 semi-circular slot, 204 keyway, 3 wheel shaft, 301 first shaft hole, 302 spoke mounting plate, 303 first bearing chamber, 304 mounting hole, 4 sprocket shaft, 401 annular groove, 402 sprocket gear, 403 second shaft hole, 404 second pin hole, 405 second screw hole, 5 end cap, 501 second bearing chamber, 502 third shaft hole, 503 first pin hole, 504 first screw hole, 6 second bearing, 7 first bearing, 8 pin post, 801 groove, 9 spring, 10 key, 11 bushing, 12 fixing stud.

### 5. SPECIFIC EMBODIMENT OF THE INVENTION

In order to make the objects, technical schemes and advantages of the embodiments of the invention clearer, the technical schemes in the embodiments of the invention will be clearly and completely described below in combination with the accompanying drawings in the embodiments of the invention, obviously, the described embodiments are some, but not all embodiments of the invention. The components of the embodiments of the invention generally described and illustrated in the drawings herein may be arranged and designed in a variety of different configurations.

In the description of the invention, it should be understood that the orientation or positional relationship indicated by the terms “center”, “upper”, “lower”, “left”, “right”, “vertical”, “horizontal” “inner”, “outer” and so on are based on the orientation or positional relationship shown in the accompanying drawings, or the orientation or positional relationship that product of the invention is usually placed in when it is used, only for the convenience of describing the invention and simplifying the description, rather than indicating or implying that the indicated device or element must have a specific orientation, as well as a specific orientation structure and operation, therefore, it should not be construed as a limitation of the invention.

In addition, the terms of “first”, “second”, “third” and so on are only used to differentiate the description, and should not be construed as indicating or implying relative importance. In addition, if the terms “horizontal”, “vertical”, “overhanging” and other terms appear, it does not mean that the component is required to be absolutely horizontal or overhanging, but can be slightly inclined. For example, “horizontal” simply means that its direction is more horizontal than “vertical”, it does not mean that the structure must be completely horizontal, but can be slightly inclined.

In the description of the invention, “a plurality of” means at least two.

In the description of the invention, it should also be noted that the terms of “arrange”, “install”, “link”, “connect”, etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

The bicycle rear-wheel drive mechanism of the invention will be further described in detail below in combination with the accompanying drawings.

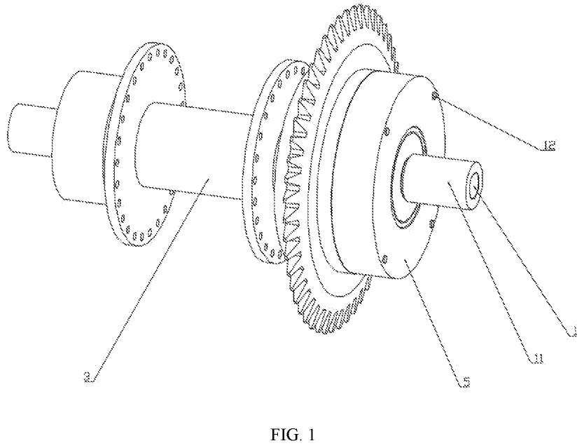

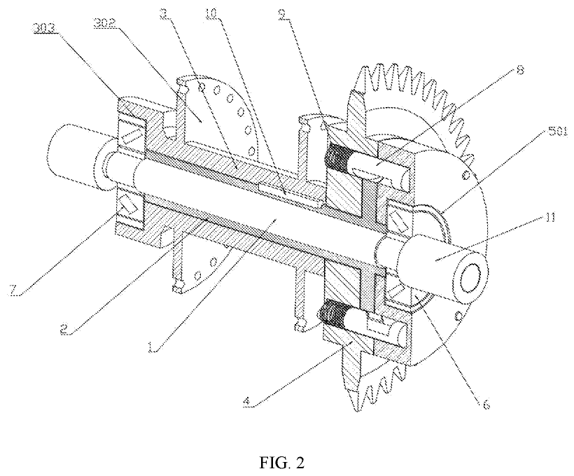

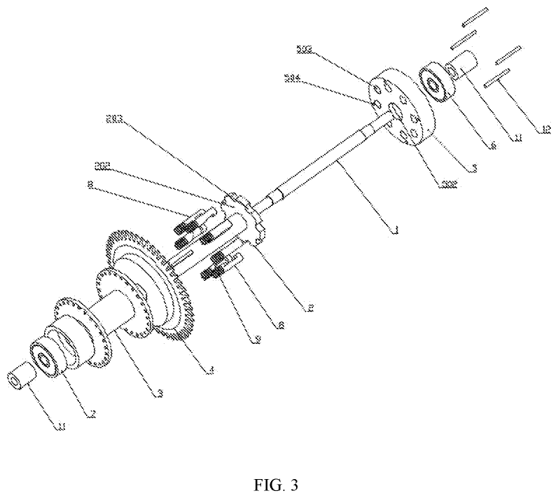

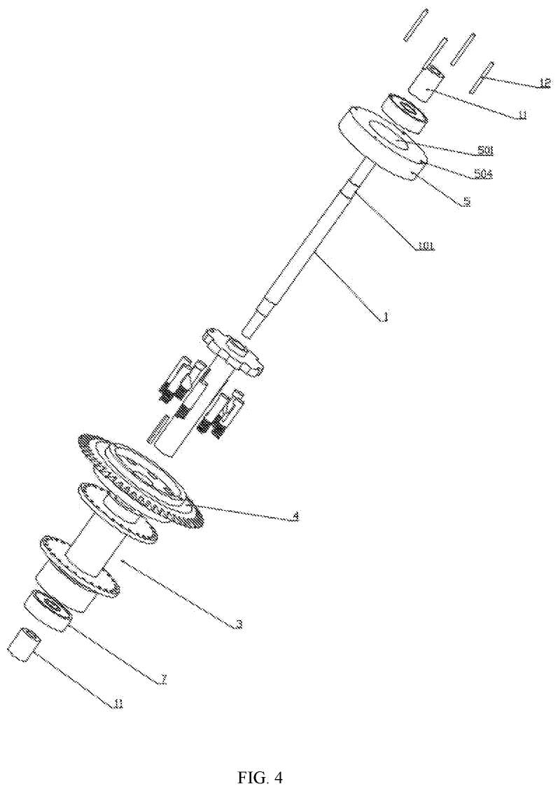

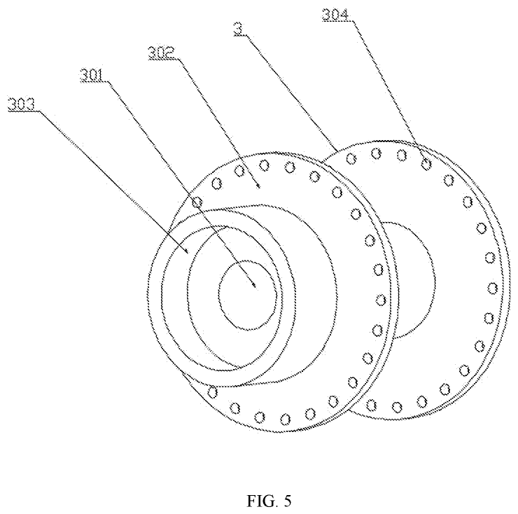

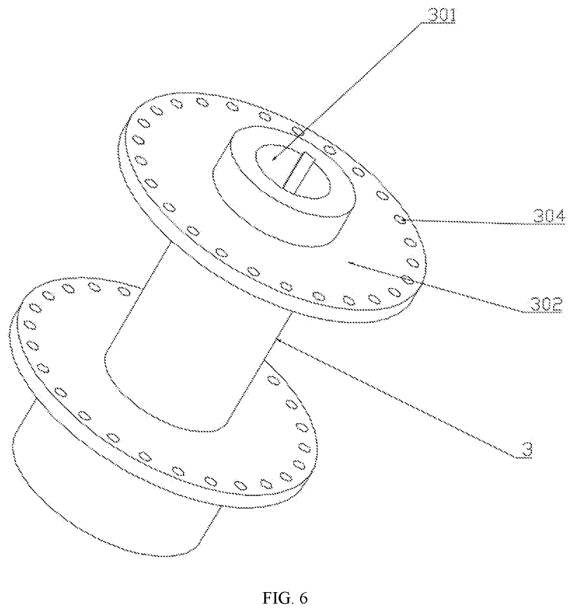

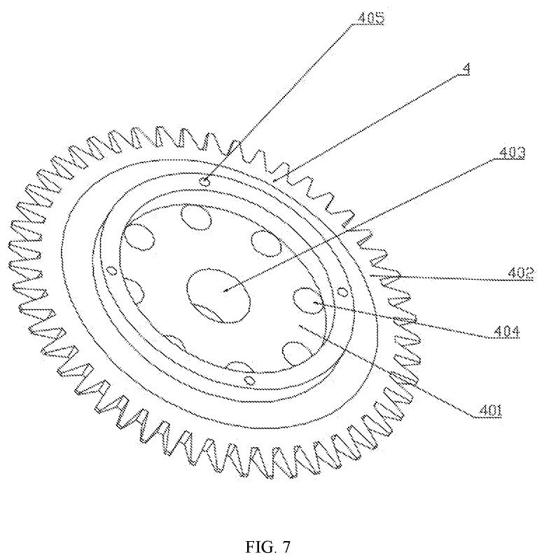

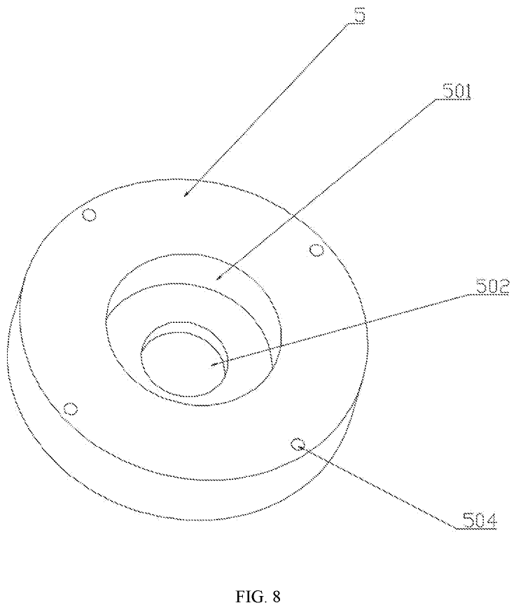

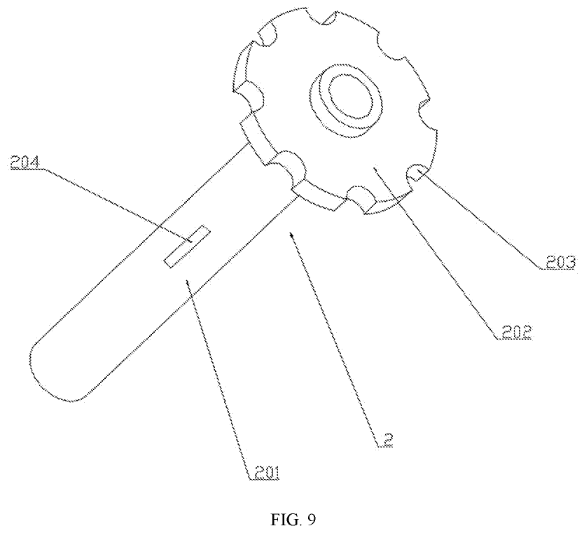

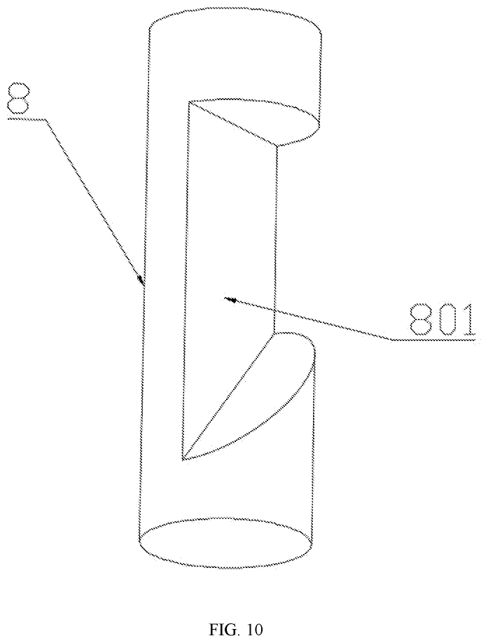

Combined with FIGS. 1 to 10, the bicycle rear-wheel drive mechanism comprises a fixed shaft 1, a hollow toothed disc shaft 2, a wheel shaft 3, a sprocket shaft 4, an end cap 5 and pin posts 8, the hollow toothed disc shaft 2 is composed of a shaft cylinder 201 and a toothed disc 202 arranged at one end of the shaft cylinder 201, the toothed disc 202 is provided with an array of semi-circular slots 203 located at the edge of the disc body;
a first bearing chamber 303 is arranged at one end of the wheel shaft 3, and a first bearing 7 is arranged inside the first bearing chamber 303, the outer peripheral surface of the wheel shaft 3 is provided with two spoke mounting plates 302 along the axial direction, and the axis of the wheel shaft 3 is provided with a first shaft hole 301;
an annular groove 401 is arranged on one side of the sprocket shaft 4, a second shaft hole 403 is arranged in the center of the annular groove 401, and the annular groove 401 is provided with second pin holes 404 in a circumferential array near the edge of the bottom of the groove, which are designed to work in conjunction with the semi-circular grooves 203;
the end of the shaft cylinder 201 of the hollow toothed disc shaft 2 away from the toothed disc 202 penetrates the second shaft hole 403 and the first shaft hole 301 in sequence and then extends to the first bearing chamber 303, the toothed disc 202 is located inside the annular groove 401;
the notch of the annular groove 401 is snap-fitted with the end cap 5, the side of the end cap 5 near the annular groove 401 is provided with first pin holes 503 coaxially arranged with the second pin holes 404, the pin posts 8 are located inside the cylindrical regions formed by the first pin holes 503 and the second pin holes 404, springs 9 are arranged between the pin posts 8 and the bottoms of the second pin holes 404, the pin posts 5 are provided with grooves 801 on one side of their bodies facing the central axis of the toothed disc 202;
on the side of the end cap 5 facing away from the annular groove 401, a second bearing chamber 501 is located at the center of the cap body, the center of the second bearing chamber 501 is provided with a third shaft hole 502, the interior of the second bearing chamber 501 is provided with a second bearing 6;
the fixed shaft 1 is arranged inside the shaft cylinder 201, the first bearing 7 and the second bearing 6 are respectively sleeved on the outer peripheral surfaces of the shaft journals 101 on both sides of the fixed shaft 1.

As a preferred implementation of this embodiment, an acute angle is set between one groove wall of the groove 801 of the pin post 8 near the wheel shaft 3 and the axis of the pin post 8, the other groove wall of the groove 801 of is perpendicular to the axis of the pin post 8, the distance between the two groove walls of the groove 801 is slightly larger than the thickness of the toothed disc 202, the angle formed by the groove wall planes on both sides of the groove 801 points to the direction in which the sprocket shaft 4 drives the hollow toothed disc shaft to rotate.

As a preferred implementation of this embodiment, the fixed shaft 1 and the shaft cylinder 201 are coaxially arranged, and the outer diameter of the fixed shaft 1 is smaller than the inner diameter of the shaft cylinder 201.

As a preferred implementation of this embodiment, the spoke mounting plates 302 are provided with mounting holes 304 evenly around their edges for installing spokes.

As a preferred implementation of this embodiment, a sprocket gear 402 is fixed on the outer peripheral surface of the sprocket shaft 4.

As a preferred implementation of this embodiment, the hollow toothed disc shaft 2 is axially provided with a keyway 204 on the outer circumferential surface, the hollow toothed disc shaft 2 and the wheel shaft 3 are circumferentially fixed by a key 10, which is arranged inside the keyway 204.

As a preferred implementation of this embodiment, second screw holes 405 are arranged at the notch of the annular groove 401, first screw holes 504 are arranged at the edge of the cover body of the end cap 5, the axes of the first screw holes 504 and the second screw holes 405 are coincident and the apertures are equal, fixing studs 12 extend into the first screw holes 504 and the second screw holes 405 in turn.

As a preferred implementation of this embodiment, the two ends of the fixed shaft 1 are respectively connected with bushings 11 of the bicycle frame.

As a preferred implementation of this embodiment, the diameter of the toothed disc 202 is slightly smaller than the inner diameter of the annular groove 401.

When this invention is specifically implemented, the foot pedal is stepped by a bicycle rider, and the driving sprocket drives the sprocket gear 402 to rotate through the chain. Because the angle formed by the groove wall planes on both sides of the groove 801 points to the direction in which the sprocket shaft 4 drives the hollow toothed disc shaft to rotate, when the sprocket shaft 4 rotates, one side of the grooves 801 of the pin posts 8 with inclined surfaces is stuck in the semi-circular slots 203 of the toothed disc 202, as a result, the pin posts 8 push the toothed disc 202 to rotate, and the shaft cylinder 201 drives the wheel shaft 3 to rotate synchronously;

When the rotation speed of the sprocket shaft 4 is less than that of the wheel shaft 3 or the rotation direction of the sprocket shaft 4 is opposite to that of the wheel shaft 3, the semi-circular slots 203 of the toothed disc 202 slide along the inclined groove walls of the grooves 801, at this time, the semi-circular slots 203 presses against the inclined groove walls of the grooves 801 to move toward the direction of the springs 9, the semi-circular slots 203 of the toothed disc 202 pass through the gaps between the two groove walls of the grooves 801 during the rotation process, and then the pin posts 8 no longer push the toothed disc 202 to rotate.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A bicycle rear-wheel drive mechanism comprises a fixed shaft, a hollow toothed disc shaft, a wheel shaft, a sprocket shaft, an end cap and pin posts, the hollow toothed disc shaft is composed of a shaft cylinder and a toothed disc arranged at one end of the shaft cylinder, the toothed disc is provided with an array of semi-circular slots located at the edge of the disc body;
a first bearing chamber is arranged at one end of the wheel shaft, and a first bearing is arranged inside the first bearing chamber, the outer peripheral surface of the wheel shaft is provided with two spoke mounting plates along the axial direction, and the axis of the wheel shaft is provided with a first shaft hole;
an annular groove is arranged on one side of the sprocket shaft, a second shaft hole is arranged in the center of the annular groove, and the annular groove is provided with second pin holes in a circumferential array near the edge of the bottom of the groove, which are designed to work in conjunction with the semi-circular grooves;
the end of the shaft cylinder of the hollow toothed disc shaft away from the toothed disc penetrates the second shaft hole and the first shaft hole in sequence and then extends to the first bearing chamber, the toothed disc is located inside the annular groove;
the notch of the annular groove is snap-fitted with the end cap, the side of the end cap near the annular groove is provided with first pin holes coaxially arranged with the second pin holes, the pin posts are located inside the cylindrical regions formed by the first pin holes and the second pin holes, springs are arranged between the pin posts and the bottoms of the second pin holes, the pin posts are provided with grooves on one side of their bodies facing the central axis of the toothed disc;
on the side of the end cap facing away from the annular groove, a second bearing chamber is located at the center of the cap body, the center of the second bearing chamber is provided with a third shaft hole, the interior of the second bearing chamber is provided with a second bearing;
the fixed shaft is arranged inside the shaft cylinder, the first bearing and the second bearing are respectively sleeved on the outer peripheral surfaces of the shaft journals on both sides of the fixed shaft.

2. The bicycle rear-wheel drive mechanism of claim 1, an acute angle is set between one groove wall of the groove of the pin post near the wheel shaft and the axis of the pin post, the other groove wall of the groove of is perpendicular to the axis of the pin post, the distance between the two groove walls of the groove is slightly larger than the thickness of the toothed disc, the angle formed by the groove wall planes on both sides of the groove points to the direction in which the sprocket shaft drives the hollow toothed disc shaft to rotate.

3. The bicycle rear-wheel drive mechanism of claim 1, the fixed shaft and the shaft cylinder are coaxially arranged, and the outer diameter of the fixed shaft is smaller than the inner diameter of the shaft cylinder.

4. The bicycle rear-wheel drive mechanism of claim 1, the spoke mounting plates are provided with mounting holes evenly around their edges for installing spokes.

5. The bicycle rear-wheel drive mechanism of claim 1, a sprocket gear is fixed on the outer peripheral surface of the sprocket shaft.

6. The bicycle rear-wheel drive mechanism of claim 1, the hollow toothed disc shaft is axially provided with a keyway on the outer circumferential surface, the hollow toothed disc shaft and the wheel shaft are circumferentially fixed by a key, which is arranged inside the keyway.

7. The bicycle rear-wheel drive mechanism of claim 1, second screw holes are arranged at the notch of the annular groove, first screw holes are arranged at the edge of the cover body of the end cap, the axes of the first screw holes and the second screw holes are coincident and the apertures are equal, fixing studs extend into the first screw holes and the second screw holes in turn.

8. The bicycle rear-wheel drive mechanism of claim 1, the two ends of the fixed shaft are respectively connected with bushings of the bicycle frame.

9. The bicycle rear-wheel drive mechanism of claim 1, the diameter of the toothed disc is slightly smaller than the inner diameter of the annular groove.

10. The bicycle rear-wheel drive mechanism of claim 1, both the first bearing and the second bearing adopt tapered roller bearings.
